(19) United States
(12) Patent Application Publication
(10) Pub. No.: US 2025/0349061 A1
(43) Pub. Date: Nov. 13, 2025

(54) Simulation System

(71) Applicant: Daifuku Co., Ltd., Osaka-shi (JP)

(72) Inventors: Akihiro Iwanaga, Komaki-shi (JP); Akira Ito, Komaki-shi (JP); Iori Takitani, Komaki-shi (JP); Tomohide Korenaga, Komaki-shi (JP)

(21) Appl. No.: 19/203,386

(22) Filed: May 9, 2025

(30) Foreign Application Priority Data
May 10, 2024 (JP) 2024-077200

(51) Int. Cl. G06T 15/00; G06T 19/00

(52) U.S. Cl. CPC G06T 15/00; G06T 19/003

(57) ABSTRACT

A simulation system includes a display device that displays an image of a virtual space and a controller. The controller includes a space information obtainer, a facility information obtainer, and a display processor. The space information obtainer obtains inner space information representing an inner space of a building. The facility information obtainer obtains facility information representing each of multiple facilities arranged in the inner space. The display processor generates, in the virtual space, based on the inner space information and the facility information, a three-dimensional representation of the inner space of the building in which the multiple facilities are arranged, and causes the display device to display the three-dimensional representation. The display processor performs a plan view display process for causing displaying of a plan view of a target facility represented in two dimensions projected on a projection plane defining a part of the inner space.

### CROSS-REFERENCE TO RELATED APPLICATION

This application claims priority to Japanese Patent Application No. 2024-077200 filed May 10, 2024, the disclosure of which is hereby incorporated by reference in its entirety.

### BACKGROUND OF THE INVENTION

### Field of the Invention

The present invention relates to a simulation system.

### Description of Related Art

Simulation systems are used for displaying, on a display device, images of a virtual space viewed from a movable viewpoint in the virtual space. An example of such a simulation system is described in Japanese Unexamined Patent Application Publication No. 2020-101872 (JP 2020-101872). In the background described hereafter, reference signs and names in parentheses are the reference signs and the names in JP 2020-101872.

A simulation system (system 100) described in JP 2020-101872 reproduces, in a virtual space, an inner space of a real building (factory 50) using inner space information (wiring model data) representing the building (factory 50). In the inner space (inside the factory 50), a facility (e.g., an object 1200) is virtually disposed with its state identifiable (either energized or de-energized). Operators view the facility (e.g., the object 1200) virtually disposed in the inner space to determine the state and the positioning of the actual facility (object 1200) in the real building (factory 50).

For various inspections and verifications of multiple facilities (e.g., objects 1200) at various positions in the building (factory 50), a simulation system may be insufficient when the system simply arranges facilities (e.g., objects 1200) in the building (factory 50) in a virtual space with information indicating its state.

### SUMMARY OF THE INVENTION

A simulation system is thus awaited for easily performing various inspections and verifications of multiple facilities arranged in an inner space of a building.

In response to the above issue, the technique described below is provided.

A simulation system causes a display device to display an image of a virtual space viewed from a movable viewpoint in the virtual space. The simulation system includes a space information obtainer that obtains inner space information representing an inner space of a building, a facility information obtainer that obtains facility information representing each of a plurality of facilities arranged in the inner space, and a display processor that generates, in the virtual space, based on the inner space information and the facility information, a three-dimensional representation of the inner space of the building in which the plurality of facilities are arranged, and causes the display device to display the three-dimensional representation as an image viewed from the movable viewpoint. The plurality of facilities include a facility selected as a target facility. The inner space includes a ceiling surface and a floor surface. One of the ceiling surface or the floor surface is a placement surface on which the target facility is placed, and the other is a facing surface facing the placement surface. The display processor performs a plan view display process for causing the display device to display a three-dimensional image of the target facility placed on the placement surface and to display, on a projection plane being at least one of the placement surface or the facing surface, a plan view of the target facility represented in two dimensions at a position of the target facility projected onto the projection plane.

The structure according to the above aspect allows, from various viewpoints, inspections of the inner space of a building and the arrangement of multiple facilities in the inner space represented in three dimensions in a virtual space. The plan view display process can also cause displaying of a plan view of a specific target facility at the corresponding position on the projection plane, which is at least one of the placement surface on which the target facility is placed or the facing surface. This structure thus allows various inspections and verifications of the target facility using the position of the target facility represented in three dimensions and the two-dimensional plan view of the target facility.

Further features and advantageous effects of the technique according to the disclosure will be apparent from exemplary and nonlimiting embodiments described below with reference to the drawings.

### BRIEF DESCRIPTION OF THE DRAWINGS

FIG. 1 is a schematic diagram of a simulation system according to a first embodiment.

FIG. 2 is a diagram of an example display 1 appearing on a display device in FIG. 1.

FIG. 3 is a diagram of an example display 2 appearing on the display device in FIG. 1.

FIG. 4 is a diagram of an example display 3 appearing on the display device in FIG. 1.

FIG. 5 is a schematic diagram of a simulation system according to a second embodiment.

FIG. 6 is a diagram of an example display appearing on a display device in FIG. 5.

FIG. 7 is a schematic diagram of a simulation system according to a third embodiment.

FIG. 8 is a schematic diagram of a process performed by the simulation system in FIG. 7.

### DESCRIPTION OF THE INVENTION

### 1. First Embodiment

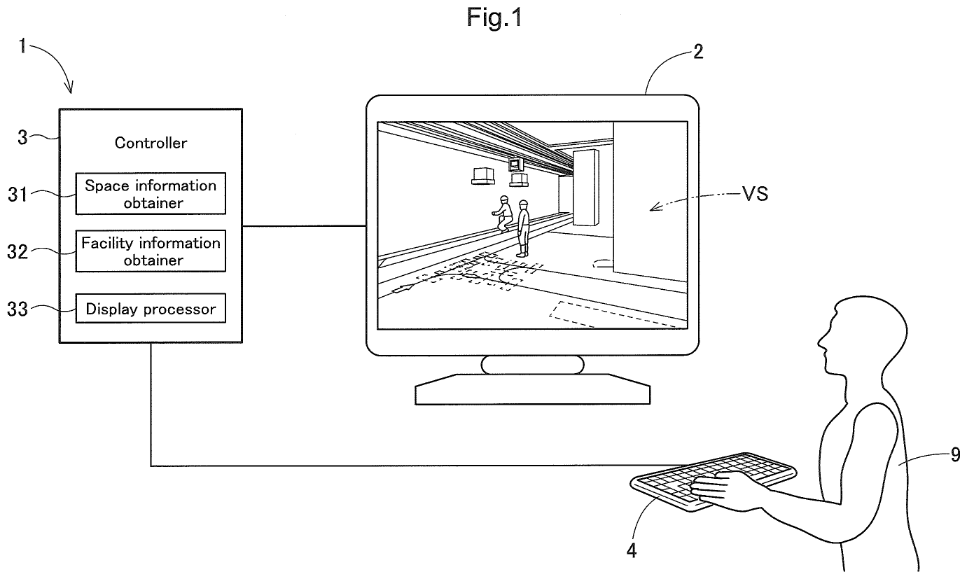

A simulation system 1 according to one or more embodiments will now be described with reference to the drawings. As shown in FIG. 1, the simulation system 1 causes a display device 2 to display images representing a virtual space VS viewed from a movable viewpoint in the virtual space VS virtually generated in a computer. The display device 2 may be a monitor, a personal computer, a tablet terminal, a smartphone, virtual reality (VR) goggles, or any other device that displays images. In FIG. 1, a personal computer is illustrated as an example of the display device 2. One or more users 9 can perform various inspections and verifications of a building 5 and facilities 6 arranged in a virtual space VS.

### 1-1. Structure

As shown in FIG. 1, the simulation system 1 includes the display device 2 and a controller 3. The controller 3 includes a processor such as a microcomputer and peripheral circuitry including a memory. The processes and functions are implemented by the hardware and a program executable on a processor such as a computer operating in cooperation with each other. The controller 3 may be a stand-alone computer or a group of computers in a cloud. The controller 3 and the display device 2 are connected with a wire or wirelessly.

The controller 3 generates the virtual space VS. Information about the virtual space VS generated by the controller 3 is transmitted to the display device 2 as image data. The display device 2 can thus display an image representing the virtual space VS. The user 9 viewing the display device 2 can recognize the virtual space VS displayed as an image. In the present embodiment, the controller 3 is a group of computers in a cloud that is accessible simultaneously by multiple users 9.

### 1-2. Controller

The controller 3 includes functional components that are implemented by programs executable on the processor and the hardware operating in cooperation with each other. The hardware implementing the functional components includes, in addition to the processor and the memory, other devices to implement each function as appropriate. In the present embodiment, the controller 3 includes, as functional components, a space information obtainer 31, a facility information obtainer 32, and a display processor 33.

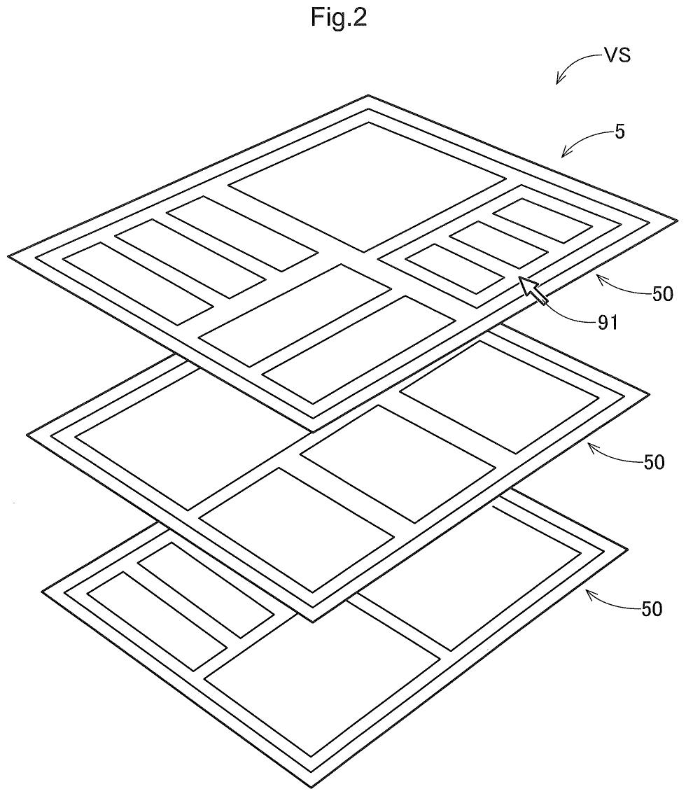

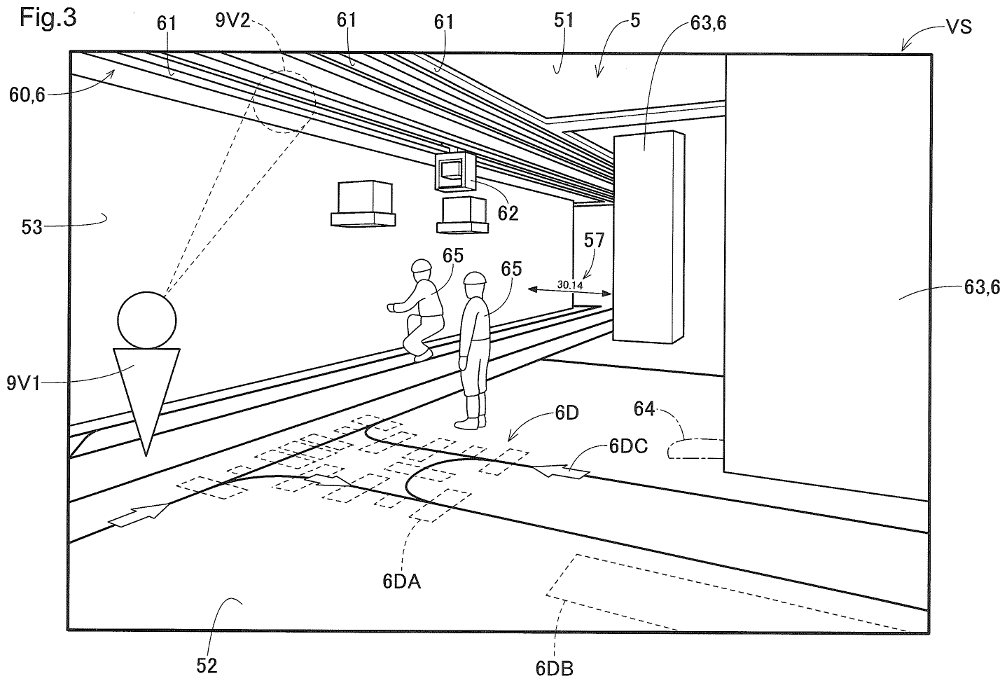

The space information obtainer 31 obtains inner space information representing the inner space of the building 5 shown in FIGS. 2 and 3. The inner space of the building 5 includes walls, pillars, floors, ceilings, and other internal structures of the building 5. The inner space information indicates the internal structures of the building 5. More specifically, the information about the internal structures of the building 5 refers to design information that defines the positions, shapes, dimensions, patterns, and other attributes of the internal structures of the building 5, including walls, pillars, floors, ceilings, and other internal structures of the building 5. The space information obtainer 31 obtains inner space information by operating with a communication device and an input device 4 for receiving inputs of inner space information, in addition to the processor and the memory. The inner space information may be obtained with, for example, a communication device receiving the information from another computer, or may be input by the user 9 with the input device 4, such as a keyboard, a mouse, a touchscreen, a touch pen, a barcode reader, a camera, or any other input device 4. FIG. 1 illustrates a keyboard as an example of the input device 4.

The facility information obtainer 32 obtains facility information representing each of the multiple facilities 6 arranged in the inner space. The facilities 6 are objects other than the internal structures of the building 5 and are arranged in the building 5 as appropriate for the use of the building 5. In the present embodiment, the building 5 is a factory. Thus, the facilities 6 may be transporters, manufacturing facilities, storage facilities, or other facilities. Facility information defines the position, the shape, the dimensions, the patterns, a combination of these, and other attributes of each facility 6. In addition, the facility information may include information about operators who work in the building 5. Similarly to the space information obtainer 31, the facility information obtainer 32 may also operate in cooperation with hardware other than the processor and the memory to implement its functions.

Based on the inner space information and the facility information, the display processor 33 generates, in the virtual space VS, three-dimensional representations of the inner space of the building 5 with the multiple facilities 6 arranged inside. The display device 2 illustrated in FIG. 1 displays an image of an inner space of a factory and multiple facilities 6 arranged in the inner space. The display processor 33 causes the display device 2 to display still images or videos. To cause the display device 2 to display videos, the display processor 33 constantly changes the display of the inner space and the multiple facilities 6 represented in the virtual space VS based on instructions from the user 9 or instructions incorporated in a computer program.

### 1-3. Processes Performed by Display Processor

Images of the virtual space VS appearing on the display device 2 and the operations that can be performed by the user 9 on the images will now be described. For ease of explanation, an image of the virtual space VS appearing on the display device 2 may be hereafter simply referred to as the virtual space VS or an image of the virtual space VS.

The display processor 33 performs an entire display process for displaying the entire inner space and a partial display process for displaying a part of the inner space. In the present embodiment, to switch from the overall display process to the partial display process, the user 9 specifies and selects an intended part in the inner space from an image displayed through the overall display process.

In the overall display process illustrated in FIG. 2, the entire view of the building 5 with multiple levels 50 is displayed by the display processor 33. More specifically, a trilevel building 5 is displayed by the display processor 33. Each level 50 is represented as a two-dimensional plane. The display processor 33 represents the entire view of the building 5 with two-dimensional planes each representing a level that are three-dimensionally spaced from one another. The two-dimensional plane representing each level 50 may be a drawing of the level 50. The user 9 can specify a portion of the inner space to be displayed through a partial display process using, for example, a pointer 91 illustrated in FIG. 2.

In the partial display process, as shown in FIG. 3, the display processor 33 causes the display device 2 to display an image of the inner space represented in three dimensions viewed from a movable viewpoint in the virtual space VS. In FIG. 3, the viewpoint is within the inner space. The display processor 33 allows display of the inner space with a ceiling surface 51, a floor surface 52, and a wall surface 53 in three dimensions. In the present embodiment, a transporter for transporting articles is placed on the ceiling surface 51, and a processing facility for processing articles is placed on the floor surface 52 as the facilities 6. In the present embodiment, operator images 65 each simulating an operator are arranged in the inner space. In the example in FIG. 3, the operator images 65 simulating operators in different postures are arranged in the inner space. The operator images 65 arranged in the inner space in this manner allow various inspections and verifications for operations performed by operators in practical situations.

To generate three-dimensional representations of the inner space and the facilities 6, for example, two-dimensional drawings of the building 5 and the facilities 6 are processed based on predetermined rules applied to these drawings. The display processor 33 can switch between displaying and hiding each component in the inner space, the facilities 6, and other objects in response to instructions from the user 9. This allows the user 9 to selectively view a target object alone and perform an inspection or a verification on the target efficiently.

The display processor 33 simulates the movement of the viewpoint and the line of sight within the virtual space VS and causes the display device 2 to display the simulated movement and the line of sight. For example, the user 9 provides an instruction to move the viewpoint to the display processor 33 through the input device 4. The display processor 33 then updates the viewpoint and the line of sight in the image appearing on the display device 2. This structure allows the user 9 to seamlessly view the inner space to efficiently perform various inspections and verifications. For the input device 4 being a mouse, for example, the user 9 moving the mouse causes the display processor 33 to update the image appearing on the display device 2, with the viewpoint moved in a direction corresponding to the movement of the mouse.

The display processor 33 may cause the display device 2 to display the viewpoint and the line of sight of another user 9. In this structure, when multiple users 9 perform various inspections and verifications in the inner space, the viewpoint and the line of sight of another user 9 appears on the display device 2, facilitating communication among the multiple users 9. In FIG. 3, a viewpoint of another user 9 is shown as an avatar 9V1 simulating the other user 9. The area to which the line of sight of the other user 9 is directed is highlighted as a highlight 9V2. The image processing performed by the display processor 33 allows one user 9 to switch the image appearing on the display device 2 from the image shown in FIG. 3 to the image of the area indicated by the highlight 9V2.

The display processor 33 may further switch the viewpoint and the line of sight between one user 9 and the other user 9 when multiple users 9 perform inspections in the inner space. This structure allows the multiple users 9 to simultaneously identify the viewpoint and the line of sight of a specific user 9, facilitating communication among the multiple users 9 when they perform various inspections and verifications in the inner space.

The display processor 33 can perform a process for selecting a specific facility 6. In the present embodiment, the user 9 selects an intended facility 6 from the multiple facilities 6. The user 9 selects the intended facility 6 using, for example, the input device 4. Hereafter, the facility 6 selected from the multiple facilities 6 is referred to as a target facility. Of the ceiling surface 51 and the floor surface 52 of the inner space, the surface on which the target facility is placed is referred to as a placement surface 54, and the surface facing the placement surface 54 is referred to as a facing surface 55. In the example in FIG. 3, a ceiling transporter 60 on the ceiling surface 51 is selected as the target facility, as described in detail later.

The display processor 33 can perform a plan view display process. The plan view process is a process for causing the display device 2 to display, in addition to a three-dimensional image of the target facility placed on the placement surface 54, a plan view 6D on a projection plane 56 at a position of the target facility projected onto the projection plane 56. The projection plane 56 is at least one of the placement surface 54 or the facing surface 55. In the present embodiment, the display processor 33 performs the plan view display process while displaying an image generated through the partial display process. In the positional relationship as projected in FIG. 3, the corresponding positions overlap each other as viewed in a vertical direction. In the plan view display process, the display processor 33 may hide the three-dimensional image of the target facility. Thus, the plan view 6D is more visible to the user 9.

The plan view 6D is a two-dimensional representation of the target facility. The plan view 6D may be a two-dimensional diagram of the target facility with the same dimensions and positional relationship as the target facility represented in three dimensions, a schematic diagram of the target facility, a diagram not showing some of these, or other diagram representing information about the target facility in two dimensions. When the plan view 6D is a schematic diagram of the target facility or a diagram not showing some information about the target facility, the target facility in the plan view 6D may not be drawn to precisely the same dimensions and positional relationship as the target facility in a three-dimensional representation, but may have a correspondence with the target facility in a three-dimensional representation. In this embodiment, the display processor 33 performs image processing to project the plan view 6D onto the projection plane 56 by defining a virtual reference point and reference coordinates on the plan view 6D and the projection plane 56. More specifically, to project the plan view 6D onto the projection plane 56, the display processor 33 superimposes the plan view 6D on the projection plane 56 by matching the reference point and the reference coordinates on the plan view 6D with the reference point and the reference coordinates on the projection plane 56.

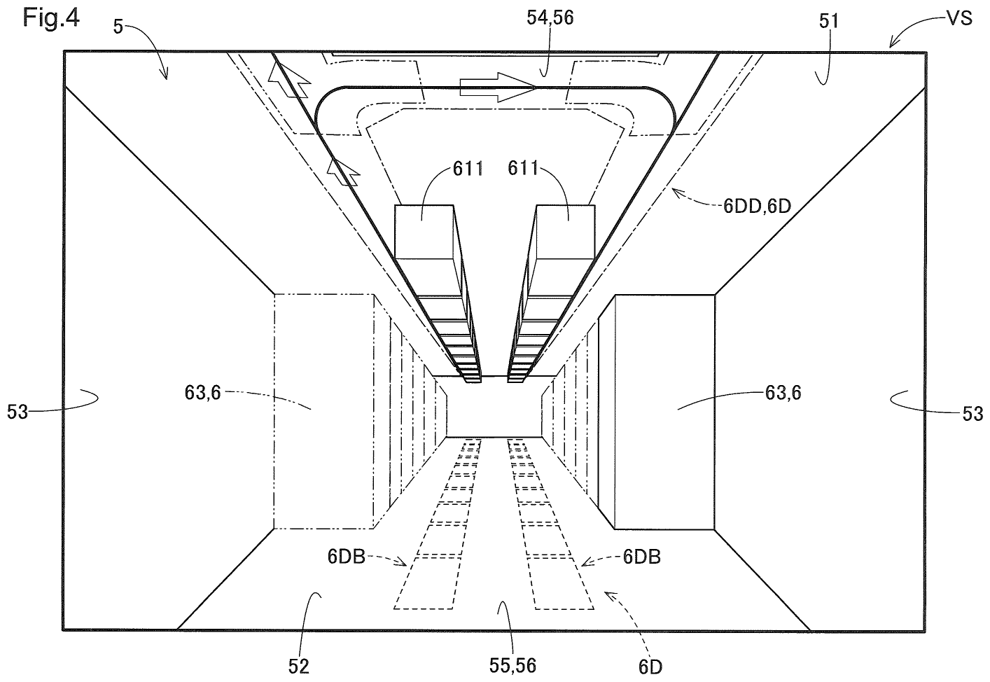

In the present embodiment, the target facility includes the ceiling transporter 60 hung from the ceiling surface 51 and transports target objects above the floor surface 52. The ceiling transporter 60 includes rails 61 hung from the ceiling surface 51, a ceiling-hung transport vehicle 62 that travels along the rails 61, a contactless power feeder (not shown), and buffers 611 (refer to FIG. 4). The contactless power feeder is a facility for feeding power to the ceiling-hung transport vehicle 62 in a contactless manner. The buffers 611 are areas for temporarily storing the target objects. For this target facility, the ceiling surface 51 is the placement surface 54, and the floor surface 52 is the facing surface 55. The projection plane 56 may include at least the facing surface 55. In FIG. 3, the facing surface 55 alone is shown as the projection plane 56. In FIG. 4, both the ceiling surface 51 and the floor surface 52 are shown as projection planes 56 onto each of which the plan view 6D is projected.

The plan view 6D includes information indicating a design drawing of the target facility. The design drawing includes a mechanical drawing, a facility layout drawing, and any other drawings prepared in designing the facility. The information indicating the design drawing includes, for example, information about dimensions, texture, patterns, and colors. In the present embodiment, the plan view 6D is a drawing of the facility 6 viewed from above.

In the example in FIG. 3, the plan view 6D is projected onto the floor surface 52. The plan view 6D is a part of the design drawing of the ceiling transporter 60 as the target facility. The design drawing of the ceiling transporter 60 includes, for example, information about the center position between the pair of rails 61, the hanging positions of the rails 61 on the ceiling surface 51, the positions of the buffers 611, and the direction in which the ceiling-hung transport vehicle 62 travels. In FIG. 3, centerlines each indicating the center position between the pair of rails 61 are projected onto the floor surface 52. A hanging diagram 6DA indicating the hanging positions, a buffer diagram 6DB indicating the positions of the buffers 611, and arrows 6DC each indicating the direction in which the ceiling-hung transport vehicle 62 travels are projected onto the floor surface 52 to be superimposed on the centerlines.

In the example in FIG. 4, information about the contactless power feeder (not shown in FIG. 4) included in the design drawing of the ceiling transporter 60 is projected onto the ceiling surface 51. A contactless feeding area 6DD as an example of the information about the contactless power feeder is projected onto the ceiling surface 51. In the contactless feeding area 6DD, the contactless power feeder can feed power to the ceiling-hung transport vehicle 62. More specifically, the contactless power feeder includes a power supply (not shown) and a feed line (not shown) to feed power from the power supply to the ceiling-hung transport vehicle 62 (not shown in FIG. 4) in a contactless manner. In the contactless feeding area 6DD, the feed line disposed along the rails 61 (not shown in FIG. 4) feeds power to the ceiling-hung transport vehicle 62 traveling along the rails 61. In a factory as an example of the building 5, or specifically in a large factory, multiple contactless feeding areas 6DD may fully cover the installation areas of the rails 61. In other words, multiple contactless power feeders may be installed in a factory. With the contactless feeding areas 6DD represented in the virtual space VS, the boundaries between different contactless feeding areas 6DD can be identified easily, thus facilitating various inspections and verifications of the contactless power feeders.

The plan view 6D may include information about a device with a movable part. The plan view 6D also includes information about a movable range 64 of the movable part. In this structure, the movable range 64 of the movable part is projected onto the projection plane 56. This facilitates various verifications and inspections in the inner space based on the movable range 64 of the movable part of the device. For example, FIG. 3 shows processing devices 63 arranged on the floor surface 52, each with a door that can be open and closed. The plan view 6D of the processing devices 63 includes information about the movable range 64 of each door. The display processor 33 projects the movable range 64 of each door in a fan shape onto the floor surface 52 that is the projection plane 56. Thus, for example, the user 9 can easily avoid installing a facility 6 in the movable range 64.

In the plan view display process, the display processor 33 uses a mirror-inverted image of the design drawing to generate the plan view 6D for the projection plane 56 being the ceiling surface 51, and uses an uninverted image of the design drawing to generate the plan view 6D for the projection plane 56 being the floor surface 52. Thus, the plan view 6D is properly projected onto the projection plane 56 without being inverted.

The display processor 33 may allow display of information such as the length of each part of an object, a distance between multiple objects, and other information about geometric physical quantities. In this structure, various inspections and verifications can be quantitatively performed on the facilities 6 installed inside the building 5. In FIG. 3, for example, a distance indication 57 indicates the distance from the wall surface 53 of the building 5 to one of the processing devices 63. The distance indication 57 shows the distance between two points preselected by the user 9. In the example in FIG. 3, the user 9 preselects the wall surface 53 and a side surface of the facility 6, and the distance indication 57 indicates 30.14 to be the minimum distance between the wall surface 53 and the side surface of the facility 6.

### 2. Second Embodiment

In the first embodiment described above, the display processor 33 performs the plan view display process for various inspections and verifications of the target facility. However, in practical applications, various facilities 6 may be arranged inside the building 5. In such a case, a target facility may be selectable by the user 9 from multiple facilities. In response to the above, a simulation system 1 according to a second embodiment allows one or more facilities 6 to be selectable as the target facility from various facilities 6.

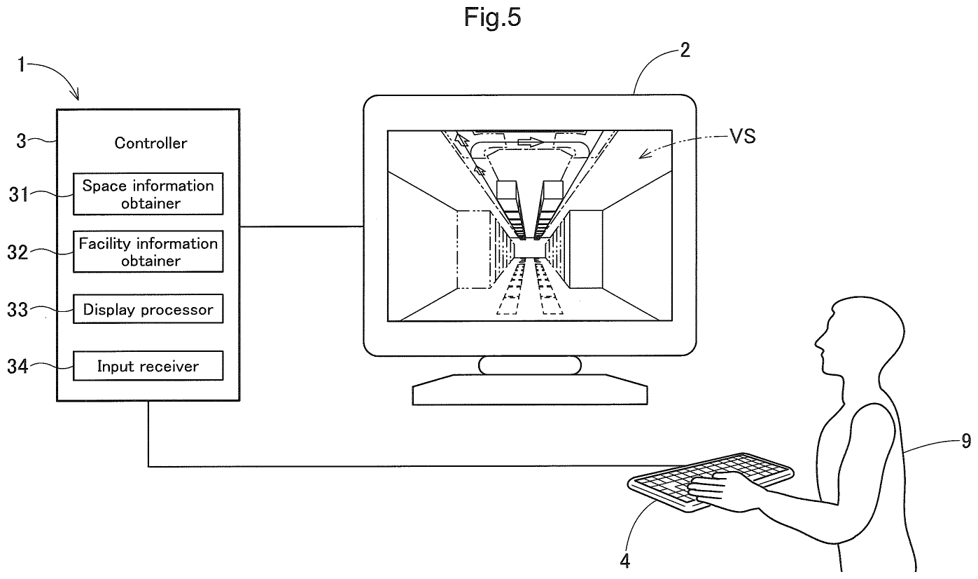

The simulation system 1 according to the second embodiment differs from the simulation system 1 according to the first embodiment in that, as shown in FIG. 5, the controller 3 further includes an input receiver 34 as a functional component. The simulation system 1 according to the second embodiment will be described below focusing on the differences from the first embodiment. The same aspects of the simulation system 1 according to the second embodiment as in the first embodiment will not be described.

The input receiver 34 receives inputs from the user 9 through the input device 4.

The display processor 33 causes the display device 2 to display a selection input image 7 through which a selection of a target facility from the multiple facilities 6 is received. The selection input image 7 includes images indicating operation icons 73, a list for selection, and other images presented to another user 9 for performing operations.

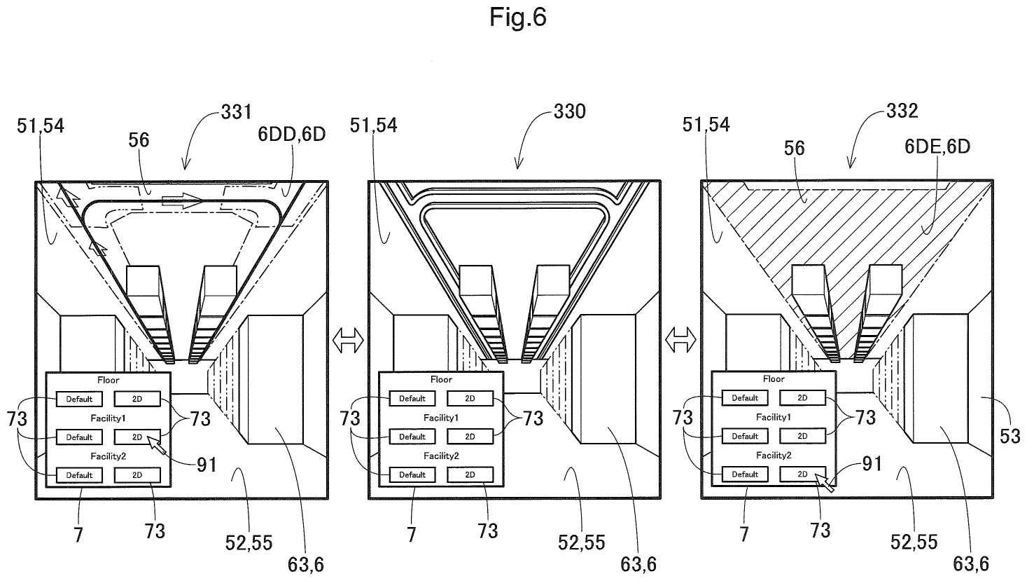

FIG. 6 shows, as an example of the selection input image 7, a selection list presenting two facilities 6 as selectable options. More specifically, the example in FIG. 6 includes a default image 330, a first image 331, and a second image 332. The default image 330 is an image without being processed through the plan view display process. The first image 331 is an image processed through the plan view display process using a plan view 6D of a first facility of the facilities 6. The first image 331 includes information about the contactless power feeder (not shown) projected onto the ceiling surface 51 as the projection plane 56. The second image 332 is an image processed through the plan view display process using a plan view 6D of a second facility of the facilities 6. The second image 332 includes information about an area 6DE that is an installation area of the ceiling transporter 60 (not fully shown) projected onto the ceiling surface 51 as the projection plane 56.

The default image 330 includes, as selectable facilities 6, Floor (indicating the floor surface 52) as well as Facility 1 (indicating the first facility) and Facility 2 (indicating the second facility). Each of the floor surface 52, the first facility, and the second facility has an operation icon 73 assigned to undergo the plan view display process (the image indicating 2D) and an operation icon 73 (the image indicating Default) assigned to cancel the plan view display process.

The user 9 can switch between the default image 330, the first image 331, and the second image 332 by operating the respective operation icons 73. For example, selecting the operation icon 73 indicating 2D for the first facility in the default image 330 causes the display processor 33 to switch the display from the default image 330 to the first image 331. For example, selecting the operation icon 73 indicating 2D for the second facility in the default image 330 causes the display processor 33 to switch the display from the default image 330 to the second image 332.

### 3. Third Embodiment

In the first or second embodiment described above, the display processor 33 performs the plan view display process for various inspections and verifications of the target facility. The results of the inspections and verifications may then be shared with, as feedback, a person 10 involved in designs of actual facilities, improvements to existing facilities, and other work performed in the real world. Thus, information about the results of inspections and verifications performed in the virtual space VS and other sharable information to be shared with the person 10 may be transmitted from the controller 3 to a terminal used by the person 10. A simulation system 1 according to a third embodiment at least transmits sharable information to a terminal other than the controller 3.

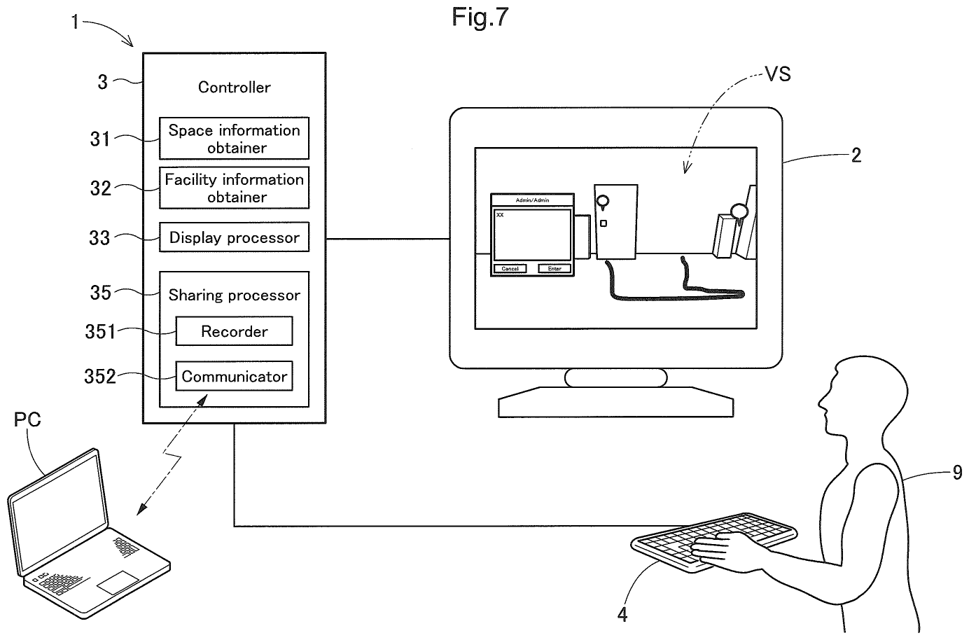

The simulation system 1 according to the third embodiment differs from the simulation system 1 according to the first or second embodiment in that, as shown in FIG. 7, the controller 3 further includes a sharing processor 35 as a functional component. The simulation system 1 according to the third embodiment will be described below focusing on the differences from the first or second embodiment. The same aspects of the simulation system 1 according to the third embodiment as in the first or the second embodiment will not be described.

The sharing processor 35 performs a process for sharing sharable information with a terminal (a different terminal personal computer or PC) other than the controller 3. The sharing processor 35 includes a recorder 351 that records sharable information and a communicator 352 that converts the sharable information recorded by the recorder 351 to a format displayable on the different terminal PC and transmits the information to the different terminal PC. This structure allows the sharable information to be in a format displayable on the different terminal PC, thus allowing the person 10 to easily view the sharable information.

In the present embodiment, the recorder 351 performs a selection process and an input process. The selection process is a process for allowing the user 9 to select an object in the virtual space VS. The input process is a process for recording sharable information about the object selected through the selection process. This structure allows the person 10 to easily identify an object corresponding to the sharable information.

As illustrated in FIG. 7, the recorder 351 records sharable information including text (text information), and the recorder 351 records sharable information including patterns (pattern information). Thus, the text information, the pattern information, or a combination of these can be recorded as sharable information, as appropriate for the results of inspections and verifications. Thus, the sharable information can be prepared in a format that allows the person 10 to easily find the results of inspections and verifications.

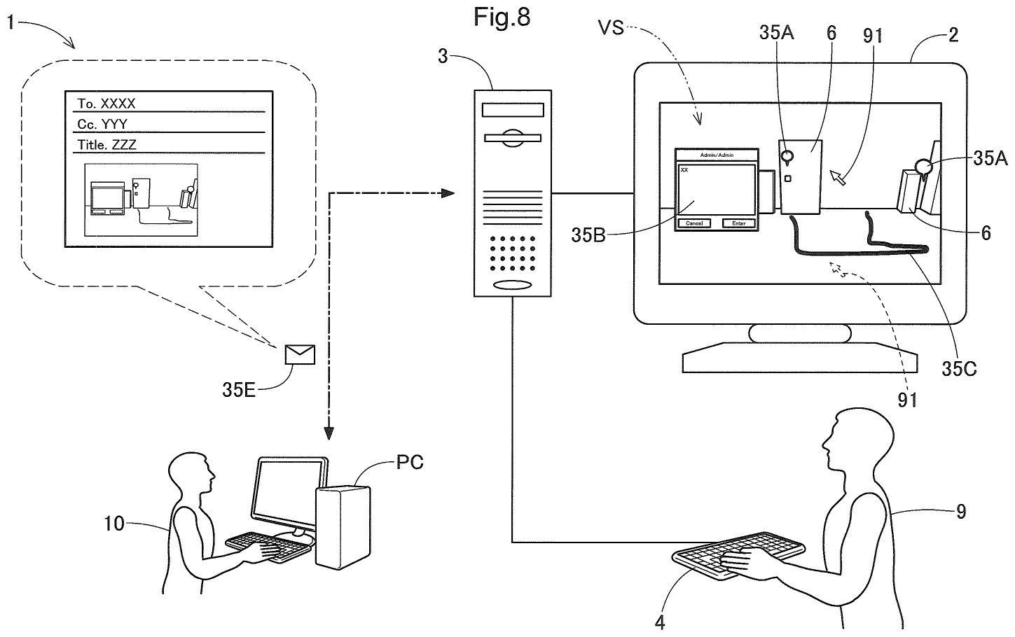

When the recorder 351 records the text information, the recorder 351 causes the user 9 to select a position or an object through the selection process. The recorder 351 illustrated in FIG. 7 causes the pointer 91 to appear in the virtual space VS, as shown in FIG. 8. The user 9 operates the pointer 91 with the input device 4 to select a position or an object. In FIG. 7, a balloon (selection icon 35A) indicates the position or the object selected by the user 9. The recorder 351 performs the input process for displaying, at a position adjacent to the selection icon 35A, an area 35B in which text can be entered. This allows the user 9 to input sharable information into the area 35B with the input device 4.

When the recorder 351 records the pattern information, the recorder 351 draws a pattern along positions selected by the user 9. In other words, when pattern information is recorded, the selection process and the input process are performed at the same time. In the example in FIG. 8, the trajectory of the pointer 91 moved by the user 9 operating the input device 4 is drawn on the floor surface 52 as a pattern 35C. The input process may be performed after a time interval from the selection process.

The communicator 352 at least transmits the sharable information to the different terminal PC different from the controller 3. Examples of the communicator 352 include a wireless communication device, a wired communication device, and any other communication device. The communicator 352 illustrated in FIG. 7 transmits sharable information in the form of an email 35E, as illustrated in FIG. 8. The email 35E is supported for display on many different terminal PCs, thus allowing many persons 10 involved to easily view the sharable information.

The communicator 352 may transmit the sharable information with additional information. The additional information includes information about the objects included in the sharable information, such as captured images recording sharable information, information about the objects (such as a name, a model number, and a serial number), links to position information in the virtual space VS, and other information to facilitate the viewing of the sharable information by the persons 10 involved. This structure allows the persons 10 to easily identify the objects included in the sharable information in the virtual space VS.

### 4. Other Embodiments

A simulation system 1 according to other embodiments will now be described.
(1) The building 5 is a factory in the above embodiments. However, the building 5 may also be a warehouse. In this case, the facilities 6 are storage shelves, transporters, and other facilities used for storing articles.
(2) In the above embodiments, the target facility is selected by the user 9 using hardware such as the input device 4. However, the target facility may be selected by the controller 3. More specifically, the computer program that operates the controller 3 may include instructions for selecting a target facility.
(3) In the above embodiments, the placement surface 54 and the facing surface 55 are described for the target facility that is the transporter placed on the ceiling surface 51. When the target is a facility 6 placed on the floor surface 52, the placement surface 54 is the floor surface 52, and the facing surface 55 is the ceiling surface 51. Examples of the facility 6 placed on the floor surface 52 include a tracked carriage with a track installed on the floor surface 52 and a conveyor.
(4) In the above embodiments, the ceiling transporter 60 is described as an example of the target facility. However, the target facility may be a conveyor hung from the ceiling.
(5) In the above embodiments, the projection plane 56 may include at least the facing surface 55. The simulation systems 1 according to the above embodiments are described as specific examples. A simulation system 1 performing the plan view display process using the placement surface 54 alone as the projection plane 56 is not excluded from the technical scope of the invention.
(6) In the above embodiments, the plan view 6D includes the information indicating the design drawing of the target facility. More specifically, the plan view 6D may include, in addition to the design drawing, a schematic diagram and a diagram with various descriptions of the facility 6.
(7) In the above embodiments, the display processor 33 allows display of the minimum distance from the wall surface 53 of the building 5 to a side surface of the facility 6. However, the display processor 33 may measure the distance between any point on a side surface of the facility 6 and any point on the wall surface 53. The display processor 33 may also display the dimensions of the facility 6 including the height of the facility 6.
(8) In the above embodiments, the display processor 33 switches between the default image 330, the first image 331, and the second image 332. In other words, in the example described above, the plan view display process is performed individually for each of the multiple facilities 6. However, the embodiments are not limited to the display processor 33 performing the plan view display process individually for each of the multiple facilities 6. For example, the plan view display process may be performed simultaneously for the multiple facilities 6.
(9) In the above embodiments, the communicator 352 at least transmits the sharable information to a different terminal PC other than the controller 3. Conversely, the communicator 352 may receive the sharable information from the different terminal PC. Similarly, the communicator 352 may receive the additional information together with the sharable information from the different terminal PC.
(10) The structure described in each of the above embodiments may be combined with any other structures described in the other embodiments unless any contradiction arises. For other structures as well, the embodiments described herein are merely illustrative in all aspects. Thus, the embodiments described herein may be modified variously as appropriate without departing from the spirit and scope of the disclosure.

### 5. Overview of Present Embodiment

An overview of the simulation system according to the embodiments described above is provided below.

A simulation system causes a display device to display an image of a virtual space viewed from a movable viewpoint in the virtual space. The simulation system includes a space information obtainer that obtains inner space information representing an inner space of a building, a facility information obtainer that obtains facility information representing each of a plurality of facilities arranged in the inner space, and a display processor that generates, in the virtual space, based on the inner space information and the facility information, a three-dimensional representation of the inner space of the building in which the plurality of facilities are arranged, and causes the display device to display the three-dimensional representation as an image viewed from the movable viewpoint. The plurality of facilities include a facility selected as a target facility. The inner space includes a ceiling surface and a floor surface. One of the ceiling surface or the floor surface is a placement surface on which the target facility is placed, and the other is a facing surface facing the placement surface. The display processor performs a plan view display process for causing the display device to display a three-dimensional image of the target facility placed on the placement surface and to display, on a projection plane being at least one of the placement surface or the facing surface, a plan view of the target facility represented in two dimensions at a position of the target facility projected onto the projection plane.

The structure according to the above aspect allows, from various viewpoints, inspections of the inner space of a building and the arrangement of multiple facilities in the inner space represented in three dimensions in a virtual space. The plan view display process can also cause displaying of a plan view of a specific target facility at the corresponding position on the projection plane, which is at least one of the placement surface on which the target facility is placed or the facing surface. This structure thus allows various inspections and verifications of the target facility using the position of the target facility represented in three dimensions and the two-dimensional plan view of the target facility.

The plan view may include information indicating a design drawing of the target facility. In the plan view display process, the display processor may use a mirror-inverted image of the design drawing to generate the plan view for the projection plane being the ceiling surface, and use an uninverted image of the design drawing to generate the plan view for the projection plane being the floor surface.

This structure allows various inspections and verifications of target facilities by comparing the arrangement of the target facility represented in three dimensions with the information indicating the design drawing included in the plan view of the target facility represented in two dimensions.

The simulation system may further include an input receiver that receives an input from a user. The display processor may cause the display device to display a selection input image through which a selection of a facility from the plurality of the facilities is received, and define the facility selected through the input receiver as the target facility.

This structure allows the user to select one or more facilities as the target facility from multiple facilities. Thus, selecting a facility for displaying a plan view in addition to the three-dimensional image allows inspections and verifications of the facility with the plan view being displayed.

The target facility may be a ceiling transporter hung from the ceiling surface to transport a target object above the floor surface. The placement surface may be the ceiling surface. The facing surface may be the floor surface. The projection plane may include at least the facing surface.

This structure allows various inspections and verifications of the ceiling transporter hung from the ceiling surface using plan views projected onto the floor surface, and thus allows, for example, efficient inspection as to, for example, whether the positional relationship between various processing facilities placed on the floor surface and the ceiling transporter is appropriate.

### INDUSTRIAL APPLICABILITY

The technique according to one or more embodiments of the disclosure is applicable to a device for displaying images representing a virtual space viewed from a movable viewpoint in the virtual space.

What is claimed is:

1. A simulation system for causing a display device to display an image of a virtual space viewed from a movable viewpoint in the virtual space, the simulation system comprising:
a space information obtainer configured to obtain inner space information representing an inner space of a building;
a facility information obtainer configured to obtain facility information representing each of a plurality of facilities arranged in the inner space; and
a display processor configured to generate, in the virtual space, based on the inner space information and the facility information, a three-dimensional representation of the inner space of the building in which the plurality of facilities are arranged, and cause the display device to display the three-dimensional representation as an image viewed from the movable viewpoint,
wherein the plurality of facilities comprises a facility selected as a target facility, the inner space comprises a ceiling surface and a floor surface, and one of the ceiling surface or the floor surface is a placement surface on which the target facility is placed and the other is a facing surface facing the placement surface,
wherein the display processor is configured to perform a plan view display process for causing the display device to display a three-dimensional image of the target facility placed on the placement surface and to display, on a projection plane that is at least one of the placement surface or the facing surface, a plan view of the target facility represented in two dimensions at a position of the target facility projected onto the projection plane.

2. The simulation system according to claim 1, wherein:
the plan view comprises information indicating a design drawing of the target facility, and
in the plan view display process, the display processor uses a mirror-inverted image of the design drawing to generate the plan view for the projection plane being the ceiling surface, and uses an uninverted image of the design drawing to generate the plan view for the projection plane being the floor surface.

3. The simulation system according to claim 1, further comprising:
an input receiver configured to receive an input from a user, and
wherein the display processor causes the display device to display a selection input image through which a selection of a facility from the plurality of the facilities is received, and defines the facility selected through the input receiver as the target facility.

4. The simulation system according to claim 1, wherein:
the target facility is a ceiling transporter hung from the ceiling surface to transport a target object above the floor surface,
the placement surface is the ceiling surface,
the facing surface is the floor surface, and
the projection plane comprises at least the facing surface.
